(19) United States
(12) Patent Application Publication
(10) Pub. No.: US 2020/0273325 A1
(43) Pub. Date: Aug. 27, 2020

(54) ROADSIDE DEVICE, COMMUNICATION SYSTEM AND PEDESTRIAN ASSISTANCE METHOD

(71) Applicant: PANASONIC INTELLECTUAL PROPERTY MANAGEMENT CO., LTD., Osaka (JP)

(72) Inventors: Tsuyoshi UENO, Kanagawa (JP); Hiroaki SUDO, Kanagawa (JP); Yoshiyuki OKUBO, Kanagawa (JP); Jun ISHIDA, Kanagawa (JP)

(73) Assignee: PANASONIC INTELLECTUAL PROPERTY MANAGEMENT CO., LTD., Osaka (JP)

(21) Appl. No.: 16/645,738

(22) PCT Filed: Jun. 7, 2018
(86) PCT No.: PCT/JP2018/021794

§ 371 Date: Mar. 9, 2020

(30) Foreign Application Priority Data
Sep. 13, 2017 (JP) 2017-175434

(51) Int. Cl. G08G 1/005; H04W 4/029; H04W 4/024; H04W 4/40; G08G 1/16

(52) U.S. Cl. CPC G08G 1/005; H04W 4/029; G08G 1/166; H04W 4/40; H04W 4/024

(57) ABSTRACT

A pedestrian terminal transmits a message including pedestrian information to a roadside machine from an ITS communicator. In a case where the message transmitted from the pedestrian terminal is received by an ITS communicator, the roadside machine accumulates the pedestrian information included in the message in a storage as passage history information and a controller generates path guidance information related to an evacuation path at a time of occurrence of a disaster based on the passage history information of the storage. Particularly, a care-needed person such as an aged person or a person frequently performing a dangerous behavior is detected, and the path guidance information for the person is generated. The message including the path guidance information is transmitted to the pedestrian terminal present nearby.

### TECHNICAL FIELD

The present invention relates to a roadside device that is installed on a road and performs road-pedestrian communication with a pedestrian device which performs a danger determination by exchanging a message including positional information with an on-vehicle device, a communication system in which the pedestrian device and the roadside device perform the road-pedestrian communication, and a pedestrian assistance method of generating information for assisting a pedestrian by collecting information from a nearby pedestrian device in the roadside device.

### BACKGROUND ART

In recent years, study for application and wide use of a safe operation assistance wireless system using an intelligent transport system (ITS) has been progressed. In the safe operation assistance wireless system, an operator of a vehicle is alerted to avoid an accident by exchanging a message including positional information and the like of the vehicle by vehicle-vehicle communication of performing communication between on-vehicle terminals mounted on vehicles or road-vehicle communication of performing communication between a roadside machine installed on a road and the on-vehicle terminal.

In addition, in recent years, pedestrian-vehicle communication of performing communication between a pedestrian terminal possessed by a pedestrian and the on-vehicle terminal has been suggested in order to prevent an accident of the pedestrian. In the pedestrian-vehicle communication, the pedestrian terminal and the on-vehicle terminal notify the presence of the pedestrian to the on-vehicle terminal and notify the presence of the vehicle to the pedestrian terminal by directly exchanging the message including the positional information and the like, thereby being able to alert both of the pedestrian and the operator of the vehicle at an appropriate timing. Thus, a significant effect is expected in terms of preventing the accident of the pedestrian.

Furthermore, a pedestrian assistance service that provides the pedestrian with various information for assisting the pedestrian is considered. For example, guidance of an evacuation path may be provided to the pedestrian for evacuation guidance at a time of occurrence of a disaster. At this point, by providing an aged person with guidance of the evacuation path appropriate for the aged person separately from other general pedestrians, the aged person can be smoothly and safely evacuated.

As a technology related to such a pedestrian assistance service, a technology for acquiring various information related to a path of a moving object by accumulating positional information of the moving object as movement history information and analyzing the movement history information, and providing the information to a user is known in the related art (refer to PTL 1).

### CITATION LIST

### Patent Literature

PTL 1: Japanese Patent Unexamined Publication No. 2003-223449

### SUMMARY OF THE INVENTION

In the technology of the related art, while various information can be provided to the user based on movement history information, a dedicated terminal needs to be possessed by a person in order to collect appropriate information. Thus, a problem of an increase in cost is present. Meanwhile, in the safe operation assistance wireless system, as described above, the pedestrian possesses the pedestrian terminal. Thus, it is considered that information is collected using the pedestrian terminal. Accordingly, a significant reduction of cost is expected.

Therefore, a main object of the present invention is to provide a roadside device, a communication system, and a pedestrian assistance method capable of generating information for assisting a pedestrian based on information collected from a pedestrian terminal.

A roadside device of the present invention is a roadside device that is installed on a road and performs road-pedestrian communication with a pedestrian device which performs a danger determination by exchanging a message including positional information with an on-vehicle device. The roadside device includes a communicator that performs the road-pedestrian communication with the pedestrian device, a storage in which in a case where the message transmitted from the pedestrian device is received by the communicator, pedestrian information included in the received message is accumulated as passage history information, and a controller that generates pedestrian assistance information for assisting a pedestrian based on the passage history information.

In addition, a communication system of the present invention is a communication system including a pedestrian device that performs a danger determination by exchanging a message including positional information with an on-vehicle device, and a roadside device installed on a road, in which the pedestrian device and the roadside device perform road-pedestrian communication, and the roadside device includes a communicator that performs the road-pedestrian communication with the pedestrian device, a storage in which in a case where the message transmitted from the pedestrian device is received by the communicator, pedestrian information included in the received message is accumulated as passage history information, and a controller that generates pedestrian assistance information for assisting a pedestrian based on the passage history information.

In addition, a pedestrian assistance method of the present invention is a pedestrian assistance method of generating information for assisting a pedestrian by collecting information from a nearby pedestrian device in a roadside device installed on a road. The pedestrian assistance method includes by the pedestrian device, transmitting a message including pedestrian information to the roadside device, and by the roadside device, in a case where the message transmitted from the pedestrian device is received, accumulating the pedestrian information included in the message as passage history information, and generating pedestrian assistance information for assisting the pedestrian based on the passage history information.

According to the present invention, information for assisting the pedestrian can be generated based on information collected from the pedestrian terminal.

### BRIEF DESCRIPTION OF DRAWINGS

FIG. 1 is an overall configuration diagram of a communication system according to a first exemplary embodiment.

FIG. 2 is a descriptive diagram illustrating a situation of path guidance according to the first exemplary embodiment.

FIG. 3 is a descriptive diagram illustrating a guidance path for each type of pedestrian according to the first exemplary embodiment.

FIG. 4 is a block diagram illustrating schematic configurations of pedestrian terminal 1 and roadside machine 5 according to the first exemplary embodiment.

FIG. 5 is a descriptive diagram illustrating one example of pedestrian information included in a message transmitted from pedestrian terminal 1 according to the first exemplary embodiment.

FIG. 6A is a flowchart illustrating an operation procedure at a time of information reception and a time of information analysis in roadside machine 5 according to the first exemplary embodiment.

FIG. 6B is a flowchart illustrating an operation procedure at the time of information reception and the time of information analysis in roadside machine 5 according to the first exemplary embodiment.

FIG. 7 is a flowchart illustrating an operation procedure at a time of user assistance in roadside machine 5 according to the first exemplary embodiment.

FIG. 8 is a descriptive diagram illustrating a situation of path guidance according to a modification example of the first exemplary embodiment.

FIG. 9 is a block diagram illustrating schematic configurations of pedestrian terminal 1 and roadside machine 5 according to the modification example of the first exemplary embodiment.

FIG. 10 is a flowchart illustrating an operation procedure at a time of user assistance in roadside machine 5 according to the modification example of the first exemplary embodiment.

FIG. 11A is a descriptive diagram illustrating a summary of a communication system according to a second exemplary embodiment.

FIG. 11B is a descriptive diagram illustrating a summary of the communication system according to the second exemplary embodiment.

FIG. 12 is a block diagram illustrating schematic configurations of pedestrian terminal 1 and roadside machine 5 according to the second exemplary embodiment.

FIG. 13A is a flowchart illustrating an operation procedure at a time of information reception and a time of information analysis in roadside machine 5 according to the second exemplary embodiment.

FIG. 13B is a flowchart illustrating an operation procedure at the time of information reception and the time of information analysis in roadside machine 5 according to the second exemplary embodiment.

FIG. 14 is a flowchart illustrating an operation procedure at a time of user assistance in roadside machine 5 according to the second exemplary embodiment.

FIG. 15 is a descriptive diagram illustrating a summary of a communication system according to a third exemplary embodiment.

FIG. 16 is a block diagram illustrating schematic configurations of pedestrian terminal 1 and roadside machine 5 according to the third exemplary embodiment.

FIG. 17A is a flowchart illustrating an operation procedure at a time of information reception and a time of information analysis in roadside machine 5 according to the third exemplary embodiment.

FIG. 17B is a flowchart illustrating an operation procedure at the time of information reception and the time of information analysis in roadside machine 5 according to the third exemplary embodiment.

FIG. 18 is a flowchart illustrating an operation procedure at a time of user assistance in roadside machine 5 according to the third exemplary embodiment.

FIG. 19 is an overall configuration diagram of a communication system according to a fourth exemplary embodiment.

FIG. 20 is a block diagram illustrating schematic configurations of pedestrian terminal 1 and roadside machine 5 according to the fourth exemplary embodiment.

FIG. 21A is a flowchart illustrating an operation procedure of pedestrian terminal 1 and roadside machine 5 according to the fourth exemplary embodiment.

FIG. 21B is a flowchart illustrating an operation procedure of pedestrian terminal 1 and roadside machine 5 according to the fourth exemplary embodiment.

FIG. 22 is a descriptive diagram illustrating one example of pedestrian information included in a message transmitted from pedestrian terminal 1 according to the fourth exemplary embodiment.

FIG. 23 is an overall configuration diagram of a communication system according to a fifth exemplary embodiment.

### DESCRIPTION OF EMBODIMENTS

A first invention conceived in order to resolve the object is a roadside device that is installed on a road and performs road-pedestrian communication with a pedestrian device which performs a danger determination by exchanging a message including positional information with an on-vehicle device. The roadside device includes a communicator that performs the road-pedestrian communication with the pedestrian device, a storage in which in a case where the message transmitted from the pedestrian device is received by the communicator, pedestrian information included in the received message is accumulated as passage history information, and a controller that generates pedestrian assistance information for assisting a pedestrian based on the passage history information.

Accordingly, information for assisting the pedestrian can be generated based on information collected from a pedestrian terminal.

A second invention is such that the controller transmits the message including the pedestrian assistance information to the pedestrian device present nearby from the communicator.

Accordingly, the pedestrian assistance information can be presented to a person possessing the pedestrian device.

A third invention is such that the controller displays the pedestrian assistance information on a display device.

Accordingly, the pedestrian assistance information can be presented to the pedestrian present nearby the display device.

A fourth invention is such that the controller transmits the message including the pedestrian assistance information to the on-vehicle device present nearby from the communicator.

Accordingly, the pedestrian assistance information can be presented to an operator of a vehicle.

A fifth invention is such that the communicator receives the message including attribute information of the pedestrian from the pedestrian device, and the controller acquires behavior pattern information of the pedestrian having a specific attribute based on the passage history information and generates the pedestrian assistance information for the pedestrian having the specific attribute as a target based on the behavior pattern information.

Accordingly, appropriate pedestrian assistance information can be generated for the pedestrian having the specific attribute as a target.

A sixth invention is such that the controller acquires the behavior pattern information related to a regular path of a care-needed person based on the passage history information, selects the regular path based on the behavior pattern information in a case where the care-needed person is detected based on the attribute information included in the message transmitted from the pedestrian device, and generates path guidance information as the pedestrian assistance information for the care-needed person as a target.

Accordingly, safe guidance can be provided to the care-needed person such as an aged person.

A seventh invention is such that the controller acquires the behavior pattern information related to a time range in which a care-needed person rides on a bus based on the passage history information, generates riding information indicating that the care-needed person rides on the bus as the pedestrian assistance information in a case where the care-needed person approaching a bus stop is detected based on the positional information and the attribute information included in the message transmitted from the pedestrian device and the time range in which the care-needed person rides on the bus is reached, and transmits the message including the riding information to the on-vehicle device of the bus from the communicator.

Accordingly, a notification of the riding of the care-needed person on the bus can be given to the operator of the bus.

An eighth invention is such that the controller acquires the behavior pattern information related to a crossing of a care-needed person based on the passage history information, and generates crossing guidance information as the pedestrian assistance information for the care-needed person as a target based on the behavior pattern information in a case where the care-needed person approaching the crossing is detected based on the attribute information and the positional information included in the message transmitted from the pedestrian device.

Accordingly, the crossing guidance information for the care-needed person as a target can be appropriately generated.

A ninth invention is such that the controller extracts the pedestrian having a specific characteristic based on the passage history information and generates the pedestrian assistance information for the pedestrian having the specific characteristic as a target.

Accordingly, appropriate pedestrian assistance information can be generated for the pedestrian having the specific characteristic as a target.

A tenth invention is such that the controller extracts the pedestrian who performs a dangerous behavior a predetermined number of times or more during a predetermined period as a dangerous person based on the passage history information, selects a path on which a vehicle traffic amount per unit time is less than or equal to a predetermined number in a case where the dangerous person is detected based on identification information included in the message transmitted from the pedestrian device, and generates path guidance information as the pedestrian assistance information for the dangerous person as a target.

Accordingly, the dangerous person frequently performing the dangerous behavior can be prevented from being involved in a traffic accident.

An eleventh invention is such that the controller extracts the pedestrian who performs a dangerous behavior a predetermined number of times or more during a predetermined period as a dangerous person based on the passage history information, selects a path along which an emergency vehicle does not pass in a case where the emergency vehicle is detected based on the attribute information included in the message transmitted from the on-vehicle device and the dangerous person is detected based on the attribute information included in the message transmitted from the pedestrian device, and generates path guidance information as the pedestrian assistance information for the dangerous person as a target.

Accordingly, by providing the dangerous person with guidance of the path along which the emergency vehicle does not pass, it is possible to avoid the emergency vehicle not being able to smoothly pass due to the dangerous behavior of the dangerous person such as sudden entrance.

A twelfth invention is such that the controller extracts the pedestrian who performs a dangerous behavior a predetermined number of times or more during a predetermined period as a dangerous person based on the passage history information, and generates crossing guidance information as the pedestrian assistance information for the dangerous person as a target in a case where the dangerous person approaching a crossing is detected based on identification information and the positional information included in the message transmitted from the pedestrian device.

Accordingly, a crossing accident of the dangerous person can be prevented.

A thirteenth invention is a communication system including a pedestrian device that performs a danger determination by exchanging a message including positional information with an on-vehicle device, and a roadside device installed on a road, in which the pedestrian device and the roadside device perform road-pedestrian communication, and the roadside device includes a communicator that performs the road-pedestrian communication with the pedestrian device, a storage in which in a case where the message transmitted from the pedestrian device is received by the communicator, pedestrian information included in the received message is accumulated as passage history information, and a controller that generates pedestrian assistance information for assisting a pedestrian based on the passage history information.

Accordingly, information for assisting the pedestrian can be generated based on information collected from the pedestrian terminal in the same manner as the first invention.

A fourteenth invention is such that a controller of the pedestrian device transmits service selection information related to use of a pedestrian assistance service from the communicator of the pedestrian device, and the controller of the roadside device generates information related to collection of a service usage fee from a user of the pedestrian assistance service based on the service selection information received by the communicator of the roadside device.

Accordingly, the service usage fee can be collected from the user who uses the pedestrian assistance service.

A fifteenth invention is a pedestrian assistance method of generating information for assisting a pedestrian by collecting information from a nearby pedestrian device in a roadside device installed on a road. The pedestrian assistance method includes by the pedestrian device, transmitting a message including pedestrian information to the roadside device, and by the roadside device, in a case where the message transmitted from the pedestrian device is received, accumulating the pedestrian information included in the message as passage history information, and generating pedestrian assistance information for assisting the pedestrian based on the passage history information.

Accordingly, information for assisting the pedestrian can be generated based on information collected from the pedestrian terminal in the same manner as the first invention.

A sixteenth invention is a pedestrian assistance method of generating information for assisting a pedestrian by collecting information from a nearby pedestrian device in a roadside device installed on a road. The pedestrian assistance method includes by the pedestrian device, transmitting a message including pedestrian information to the roadside device, and by the roadside device, in a case where the message including attribute information of the pedestrian is received from the pedestrian device, accumulating the pedestrian information included in the message as passage history information, and acquiring behavior pattern information of the pedestrian having a specific attribute based on the passage history information and generating pedestrian assistance information for the pedestrian having the specific attribute as a target based on the behavior pattern information.

Accordingly, information for assisting the pedestrian can be generated based on information collected from the pedestrian terminal in the same manner as the first invention. Particularly, appropriate pedestrian assistance information can be generated for the pedestrian having the specific attribute as a target.

Hereinafter, exemplary embodiments of the present invention will be described with reference to the drawings.

### First Exemplary Embodiment

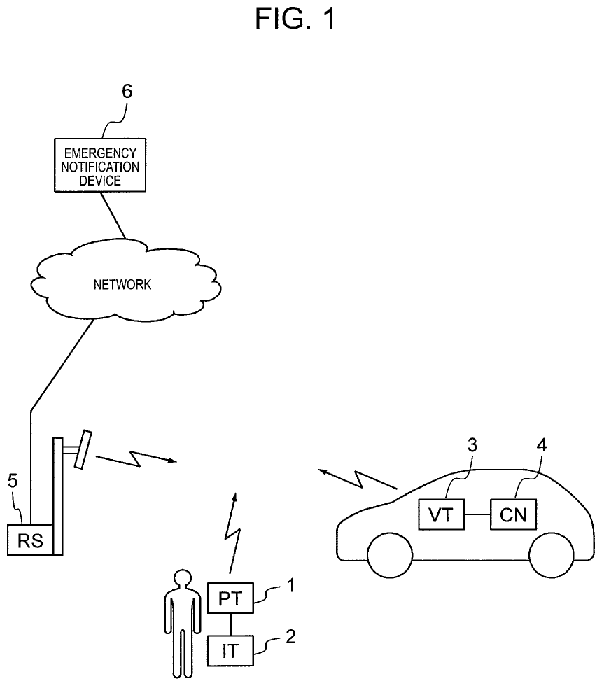

FIG. 1 is an overall configuration diagram of a communication system according to a first exemplary embodiment.

The communication system includes pedestrian terminal 1 (pedestrian device) and portable information terminal 2 carried by a pedestrian, on-vehicle terminal 3 (on-vehicle device) and car navigation device 4 mounted on a vehicle (moving object), roadside machine 5 (roadside device), and emergency notification device 6. Pedestrian-vehicle communication is performed between pedestrian terminal 1 and on-vehicle terminal 3, and road-pedestrian communication is performed between pedestrian terminal 1 and roadside machine 5.

In the pedestrian-vehicle communication, a message that includes necessary information such as positional information is transmitted and received between pedestrian terminal 1 and on-vehicle terminal 3. In the pedestrian-vehicle communication, the message is transmitted and received by ITS wireless communication, that is, wireless communication that uses a frequency band (for example, a 700 MHz band or a 5.8 GHz band) employed in a safe operation assistance wireless system which uses an intelligent transport system (ITS).

In the present exemplary embodiment, besides the pedestrian-vehicle communication, the road-pedestrian communication of transmitting and receiving the message between roadside machine 5 and pedestrian terminal 1 and road-vehicle communication of transmitting and receiving the message between roadside machine 5 and on-vehicle terminal 3 are performed. However, the road-pedestrian communication and the road-vehicle communication are the same ITS wireless communication as the pedestrian-vehicle communication, and the message transmitted and received by the pedestrian-vehicle communication, the road-pedestrian communication, and the road-vehicle communication is based on common specifications (data configuration). In addition, while the message is transmitted by broadcasting, information for a specific device as a target can be transmitted by adding identification information (a terminal ID) of a device as a recipient to the message.

Pedestrian terminal 1 is connected to portable information terminal 2. Portable information terminal 2 is a smartphone, a mobile phone, a tablet terminal, a wearable terminal, or the like. In pedestrian terminal 1, in a case where it is determined that alert is necessary by transmitting and receiving the message with on-vehicle terminal 3, an alert instruction is output to portable information terminal 2. In portable information terminal 2, an alert output operation (for example, voice output or vibration) for the pedestrian is performed in response to the instruction from pedestrian terminal 1.

On-vehicle terminal 3 is connected to car navigation device 4. Car navigation device 4 provides path guidance to an operator. In on-vehicle terminal 3, in a case where it is determined that alert is necessary by transmitting and receiving the message with pedestrian terminal 1, the alert instruction is output to car navigation device 4. In car navigation device 4, the alert output operation (for example, voice output or screen display) for the operator is performed in response to the instruction from on-vehicle terminal 3.

Pedestrian terminal 1 may be incorporated in portable information terminal 2. On-vehicle terminal 3 may be incorporated in car navigation device 4.

Pedestrian terminal 1 itself may perform the alert output operation. On-vehicle terminal 3 itself may perform the alert output operation. On-vehicle terminal 3 may communicate with portable information terminal 2 possessed by the operator and cause portable information terminal 2 to perform the alert output operation for the operator.

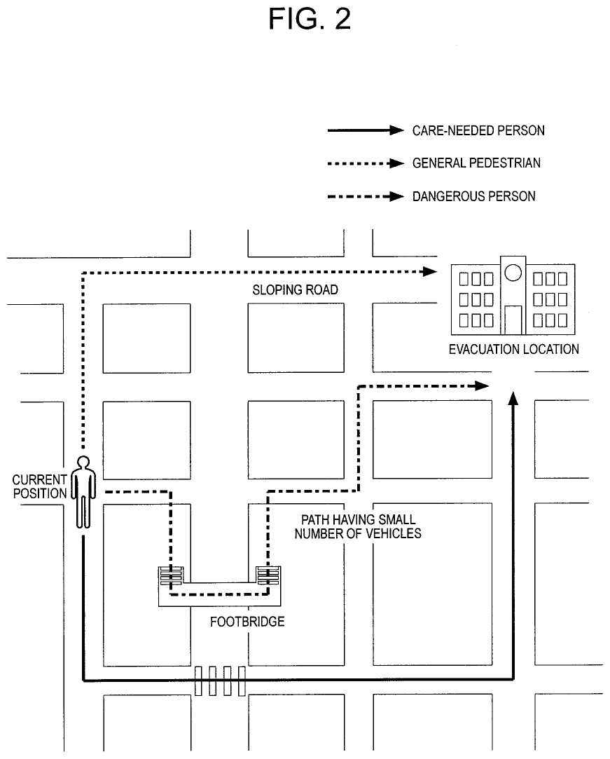

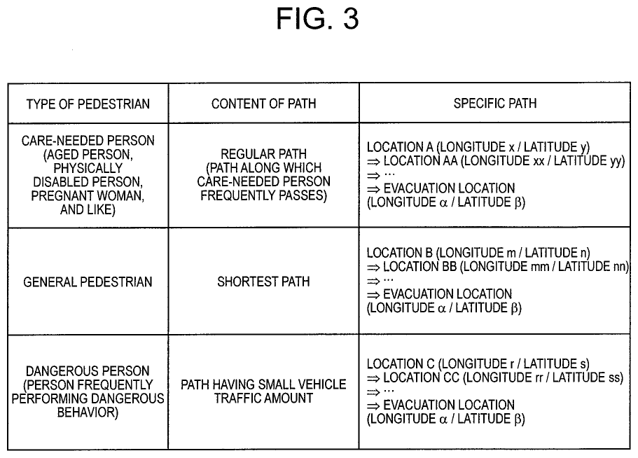

Next, a summary of path guidance provided by roadside machine 5 according to the first exemplary embodiment will be described. FIG. 2 is a descriptive diagram illustrating a situation of the path guidance for evacuation guidance at a time of occurrence of a disaster. FIG. 3 is a descriptive diagram illustrating a guidance path for each type of pedestrian.

In the present exemplary embodiment, roadside machine 5 provides the path guidance for evacuation guidance at the time of occurrence of the disaster using pedestrian terminal 1 possessed by each person. Particularly, in the present exemplary embodiment, guidance of different evacuation paths is provided depending on the type of pedestrian.

A care-needed person such as an aged person is provided with guidance of a regular path (a path along which the care-needed person frequently passes). The regular path is a path along which the care-needed person is used to pass, and is a path that has a small number of steep slopes or steps and a small vehicle traffic amount and along which the care-needed person easily passes. By providing guidance of such a path, the care-needed person who may not easily evacuate quickly can be smoothly evacuated. In addition, in a case where a plurality of regular paths are present, guidance of a path that is not congested may be provided. A case where an obstacle or the like falls on a road is also considered at a time of a disaster or the like. In such a case, guidance of a path that has a small number of fallen obstacles or the like may be provided.

In a case where a facility such as a community center as an evacuation location is frequently used, a path to the evacuation location is included in the regular paths of individual persons. Thus, the regular path to the evacuation location may be selected. However, in a case where the facility as the evacuation location is not frequently used, the evacuation location is away from the regular path. Thus, the evacuation location cannot be reached through the regular path. In this case, first, the regular path to a location close to the evacuation location may be selected. In a section from the location to the evacuation location, a path appropriate for the aged person may be selected based on characteristics of the road.

In addition, the regular path of each person may not match. In this case, guidance of the regular paths of the individual persons may be provided. However, in a case where the number of care-needed persons is increased, a process for the path guidance becomes complicated. Thus, guidance of the path may be provided by selecting an optimal path from the regular path of each person. Alternatively, guidance of the optimal path may be provided to a person who is considered to have the highest possibility of delayed escaping at the time of the disaster among the aged persons.

The care-needed persons include a physically disabled person, a pregnant woman, and the like in addition to the aged person.

Meanwhile, guidance of the shortest path is provided to a general pedestrian. Particularly, the general pedestrian is provided with guidance of a different path from the care-needed person such as the aged person. Accordingly, it is possible to avoid congestion of the evacuation path of the care-needed person.

In addition, a dangerous person (a person frequently performing a dangerous behavior) is provided with guidance of a path that has a small vehicle traffic amount, specifically, a vehicle traffic amount per unit time that is less than or equal to a predetermined number, and on which a traffic accident is unlikely to occur. In addition, the dangerous person is provided with a different path from the care-needed person such as the aged person. The dangerous person does not have a physically disadvantageous condition unlike the care-needed person and thus, can be provided with guidance of a path that has a relatively large number of footbridges, steep slopes, or steps. A case where an obstacle or the like falls on the road is also considered at the time of the disaster or the like. In such a case, guidance of a path having a relatively large number of fallen obstacles or the like can also be provided. Accordingly, the dangerous person can be prevented from being involved in a traffic accident. In addition, it is possible to avoid congestion of the evacuation path of the care-needed person. In addition, it is possible to avoid the dangerous person hindering the evacuation of the aged person by performing a dangerous behavior on the care-needed person.

In addition, the dangerous person may be provided with guidance of a different path from the general pedestrian in addition to the care-needed person such as the aged person. Accordingly, it is possible to avoid the dangerous person hindering the evacuation of other pedestrians.

In addition, an assisting person, that is, a person who can help the evacuation of the care-needed person at the time of occurrence of evacuation like a person working as a helper or a volunteer, is provided with guidance of the same path as the care-needed person. An applicant or the like for the assisting person may be registered in advance, and the registered person may be provided with guidance of the same path as the care-needed person.

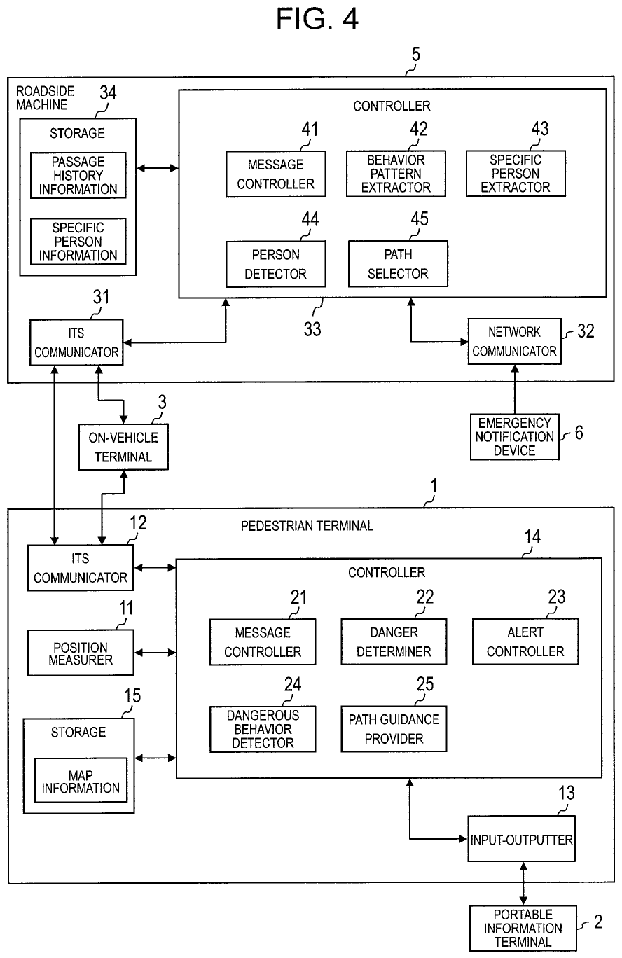

Next, schematic configurations of the pedestrian terminal and the roadside machine according to the first exemplary embodiment will be described. FIG. 4 is a block diagram illustrating the schematic configurations of pedestrian terminal 1 and roadside machine 5.

Pedestrian terminal 1 includes position measurer 11, ITS communicator 12, input-outputter 13, controller 14, and storage 15.

Position measurer 11 acquires positional information of a host device by measuring a position of the host device using a satellite position measurement system such as a global positioning system (GPS) or a quasi-zenith satellite system (QZSS). The positional information of the host device may be acquired using a position measurement function of portable information terminal 2.

ITS communicator 12 transmits and receives the message with roadside machine 5 by ITS communication (road-pedestrian communication) and transmits and receives the message with on-vehicle terminal 3 by ITS communication (pedestrian-vehicle communication).

Input-outputter 13 inputs and outputs information with portable information terminal 2. Based on the information output from input-outputter 13, an alert operation for the pedestrian is performed in portable information terminal 2.

Storage 15 stores map information and a program and the like executed by a processor constituting controller 14. The map information may be acquired from portable information terminal 2.

Controller 14 includes message controller 21, danger determiner 22, alert controller 23, dangerous behavior detector 24, and path guidance provider 25. Controller 14 is configured with the processor. Each unit of controller 14 is implemented by causing the processor to execute the program stored in storage 15.

Message controller 21 controls transmission of the message including pedestrian information such as a terminal ID and the positional information.

Danger determiner 22 determines whether or not there is a danger of collision between the vehicle and the host pedestrian based on the positional information of the host pedestrian acquired by position measurer 11 and the positional information of the vehicle included in the message received from on-vehicle terminal 3.

Alert controller 23 alerts the host pedestrian depending on a determination result of danger determiner 22. In the present exemplary embodiment, the alert instruction is output to portable information terminal 2 through input-outputter 13, and the alert output operation (for example, voice output or vibration) for the pedestrian is performed in portable information terminal 2 in response to the instruction.

Dangerous behavior detector 24 detects a dangerous behavior of the host pedestrian such as sudden entrance onto the road based on positional information of the host pedestrian acquired by position measurer 11 and the map information of storage 15.

Path guidance provider 25 performs provides the path guidance to the host pedestrian based on path guidance information included in the message received from roadside machine 5 by ITS communicator 12. In the path guidance, the evacuation path is provided to the pedestrian by displaying straight forward, right turn, and left turn arrows at each intersection on a guidance screen. While the path guidance can also be provided by pedestrian terminal 1 itself, the path guidance screen may be displayed on portable information terminal 2.

Roadside machine 5 includes ITS communicator 31, network communicator 32, controller 33, and storage 34.

ITS communicator 31 transmits and receives the message with pedestrian terminal 1 by ITS communication (road-pedestrian communication) and transmits and receives the message with on-vehicle terminal 3 by ITS communication (road-vehicle communication).

Network communicator 32 communicates with emergency notification device 6 through a network of cellular communication, wireless LAN communication, the Internet, or the like and receives an emergency notification (an emergency call) transmitted from emergency notification device 6 at the time of occurrence of the disaster.

Storage 34 stores a program and the like executed by a processor constituting controller 33. In addition, storage 34 stores the pedestrian information included in the message received from pedestrian terminal 1 as passage history information. At this point, the pedestrian information in a predetermined period (for example, one week or one month) is accumulated as the passage history information and is deleted after an elapse of the predetermined period. In addition, storage 34 stores specific person information acquired by controller 33.

Controller 33 includes message controller 41, behavior pattern extractor 42, specific person extractor 43, person detector 44, and path selector 45. Controller 33 is configured with the processor. Each unit of controller 33 is implemented by causing the processor to execute the program stored in storage 34.

In a case where the message transmitted from pedestrian terminal 1 is received by ITS communicator 31, message controller 41 stores the pedestrian information included in the message in storage 34 as the passage history information. In addition, a message that includes evacuation path information acquired by path selector 45 is transmitted to pedestrian terminal 1 from ITS communicator 31.

Behavior pattern extractor 42 extracts the passage history information of the care-needed person such as the aged person based on attribute information of each pedestrian in the passage history information of storage 34, and extracts the regular path (a path along which the care-needed person frequently passes) of the care-needed person as behavior pattern information of the care-needed person based on positional information of the care-needed person in the passage history information.

Specific person extractor 43 extracts the dangerous person (a person frequently performing the dangerous behavior) based on dangerous behavior information in the passage history information of storage 34, and stores the terminal ID of pedestrian terminal 1 corresponding to the dangerous person in storage 34 as the specific person information. The dangerous behavior information includes a date and time at which the pedestrian performs the dangerous behavior. The dangerous person is extracted by statistically processing the dangerous behavior information. Specifically, in a case where a person performs the dangerous behavior (sudden entrance, road crossing, or the like) a predetermined number of times or more during a predetermined period, the person is determined as the dangerous person.

Person detector 44 detects the care-needed person such as the aged person based on the attribute information included in the message received from pedestrian terminal 1 by ITS communicator 31. In addition, the dangerous person (a person frequently performing the dangerous behavior) is detected based on the terminal ID included in the message received from pedestrian terminal 1 and the specific person information of storage 34.

Path selector 45 generates the evacuation path information by selecting the evacuation path from the current position to the evacuation location depending on the type of pedestrian detected by person detector 44. In the present exemplary embodiment, the evacuation path for the care-needed person is selected in a case where the care-needed person such as the aged person is detected by person detector 44. The evacuation path for the dangerous person is selected in a case where the dangerous person (a person frequently performing the dangerous behavior) is detected. The evacuation path for the general pedestrian is selected in a case where the general pedestrian is detected (refer to FIG. 3).

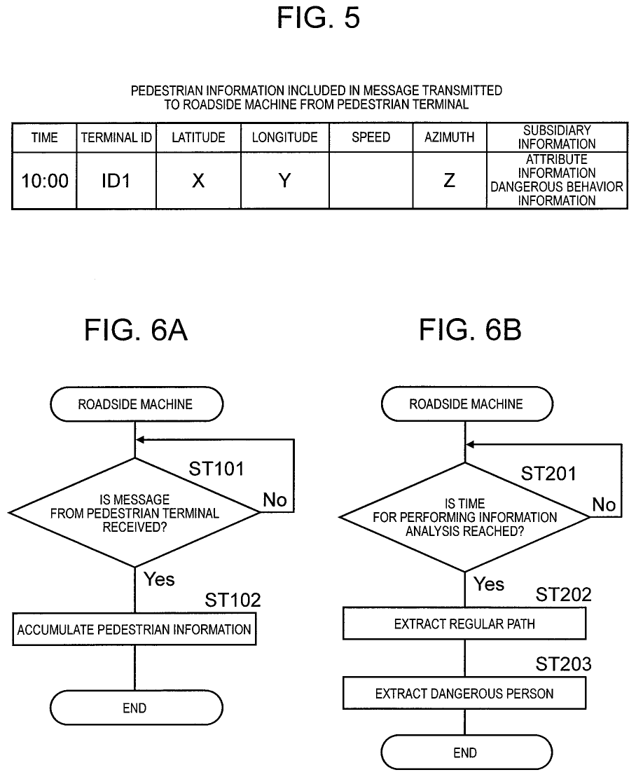

Next, the message transmitted from pedestrian terminal 1 according to the first exemplary embodiment will be described. FIG. 5 is a descriptive diagram illustrating one example of the pedestrian information included in the message transmitted from pedestrian terminal 1.

The message transmitted to roadside machine 5 from pedestrian terminal 1 includes, as the pedestrian information, each information of a time, the terminal ID of pedestrian terminal 1, a position (a latitude and a longitude) of pedestrian terminal 1, a speed, and an azimuth and subsidiary information. The subsidiary information includes the attribute information of the pedestrian such as sex and age and the dangerous behavior information related to the dangerous behavior. The subsidiary information is stored in an extended region of the message of ITS communication.

In addition to sex and age, the attribute information also includes information for identifying the care-needed person, for example, information indicating the aged person, the physically disabled person, or the pregnant woman. In addition, the attribute information includes information that indicates the assisting person such as the helper who helps the evacuation of the care-needed person.

In addition, the attribute information may be transmitted by adding the attribute information to a periodically transmitted message as necessary, or may be transmitted by adding the attribute information to the message at a predetermined interval. In roadside machine 5, even in a case the message not including the attribute information is received, the attribute information of pedestrian terminal 1 as a transmission source of the message can be acquired from the previously acquired attribute information by comparing the terminal ID.

Next, an operation procedure at a time of information reception and a time of information analysis in roadside machine 5 according to the first exemplary embodiment will be described. FIG. 6A and FIG. 6B are flowcharts illustrating the operation procedure of roadside machine 5.

As illustrated in FIG. 6A, in roadside machine 5, in a case where the message transmitted from pedestrian terminal 1 is received by ITS communicator 31 (Yes in ST101), the pedestrian information included in the message is accumulated in storage 34 as the passage history information (ST102). Pedestrian terminal 1 periodically transmits the message including the pedestrian information.

As illustrated in FIG. 6B, in roadside machine 5, in a case where a time (timing) for performing the information analysis is reached (Yes in ST201), behavior pattern extractor 42 extracts the regular path (a path along which the care-needed person frequently passes) of the care-needed person such as the aged person based on the passage history information of storage 34 and stores the regular path in storage 34 as the information analysis (ST202). In addition, specific person extractor 43 extracts the dangerous person (a person frequently performing the dangerous behavior) based on the dangerous behavior information in the passage history information of storage 34 and stores the dangerous person in storage 34 as the specific person information (ST203).

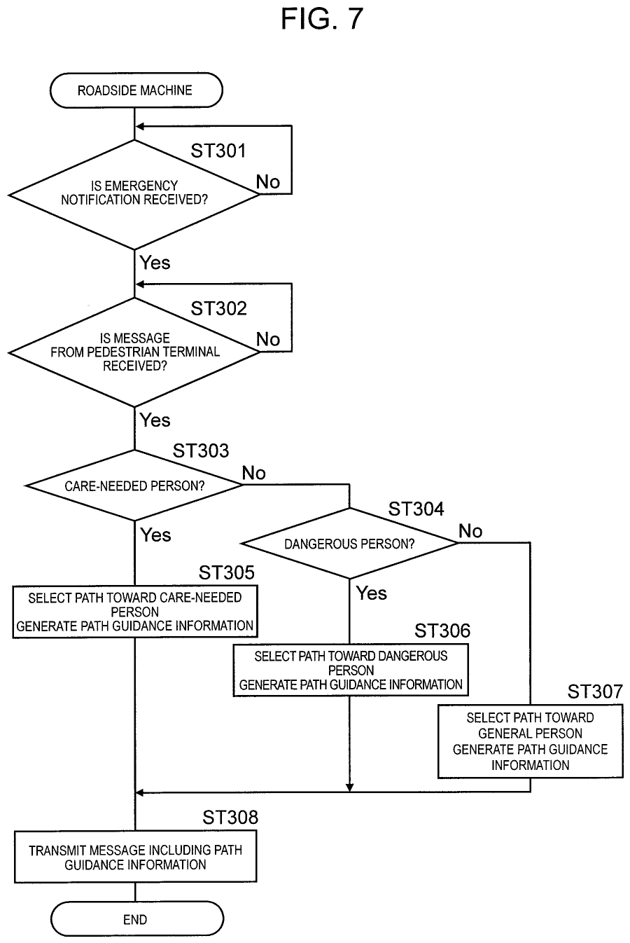

Next, an operation procedure at a time of user assistance in roadside machine 5 according to the first exemplary embodiment will be described. FIG. 7 is a flowchart illustrating the operation procedure of roadside machine 5.

In roadside machine 5, in a case where the emergency notification (the emergency call) transmitted from emergency notification device 6 is received (Yes in ST301), and the message transmitted from pedestrian terminal 1 is further received (Yes in ST302), person detector 44 determines whether or not a pedestrian present nearby the host device is the care-needed person such as the aged person based on the attribute information included in the message (ST303).

In a case where the pedestrian is the care-needed person (Yes in ST303), path selector 45 generates the path guidance information by selecting the path for the care-needed person (ST305). Even in a case where the pedestrian is the assisting person such as the helper, the path for the care-needed person is selected.

Meanwhile, in a case where the pedestrian is not the care-needed person (No in ST303), next, person detector 44 determines whether or not the pedestrian is the dangerous person (a person frequently performing the dangerous behavior) based on the terminal ID included in the message and the specific person information of storage 34 (ST304).

In a case where the pedestrian is the dangerous person (Yes in ST304), path selector 45 generates the path guidance information by selecting the path for the dangerous person (ST306). Meanwhile, in a case where the pedestrian is not the dangerous person (No in ST304), the path guidance information is generated by selecting the path for the general pedestrian (ST307).

Next, message controller 41 generates the message including the path guidance information acquired by path selector 45 and transmits the message to pedestrian terminal 1 from ITS communicator 31 (ST308).

In a case where a plurality of pedestrians are present nearby the host device, the above processes (ST302 to ST308) are repeated.

In the present exemplary embodiment, guidance of the evacuation path at the time of occurrence of the disaster, that is, the path from the current position to the evacuation location, is provided as the path guidance. However, the guidance of the evacuation path is not for limitation purposes. For example, guidance of a home returning path, that is, a path from the current position to home, may be provided. Accordingly, the care-needed person can safely return to home in a case where the care-needed person is in a state of not recognizing a returning path due to dementia.

In addition, the path guidance for preventing a fight between dogs at a time of walking a dog can be provided. In this case, pedestrian terminal 1 registers information indicating that the dog is walking in the attribute information and transmits the message including the attribute information to roadside machine 5. Roadside machine 5 acquires the regular path of the pedestrian walking the dog based on the attribute information included in the passage history information. The pedestrian who is walking the dog is provided with guidance of a path along which another pedestrian with a dog does not pass.

In addition, in the present exemplary embodiment, since the guidance of the evacuation path at the time of occurrence of the disaster is provided, the process of the path guidance is started by a trigger of receiving the emergency notification. In other path guidance, the process of the path guidance may be started by a trigger of not being present near a predetermined location (for example, a destination or an intermediate location) at a predetermined time. For example, in the guidance of the home returning path, in a case where the care-needed person stays outside in a time range in which the care-needed person is to be present at home, the process of the path guidance is started in order to prompt a return to home.

In addition, in the present exemplary embodiment, a case where the path for the care-needed person such as the aged person is displayed on pedestrian terminal 1 or portable information terminal 2 is described. Alternatively, the path may be displayed on digital signage installed on a street or a display device disposed in a vending machine, a power pole, or the like. The aged person mostly has disabled eyes. Thus, displaying the path on the digital signage or the like having a large screen is more advantageous in that the aged person easily sees the path. In this case, the digital signage or the like can receive and display the path guidance information by performing communication between pedestrian terminal 1 and the digital signage or the like using low power communication and giving a notification of the path guidance information received by pedestrian terminal 1 to the digital signage or the like.

### Modification Example of First Exemplary Embodiment

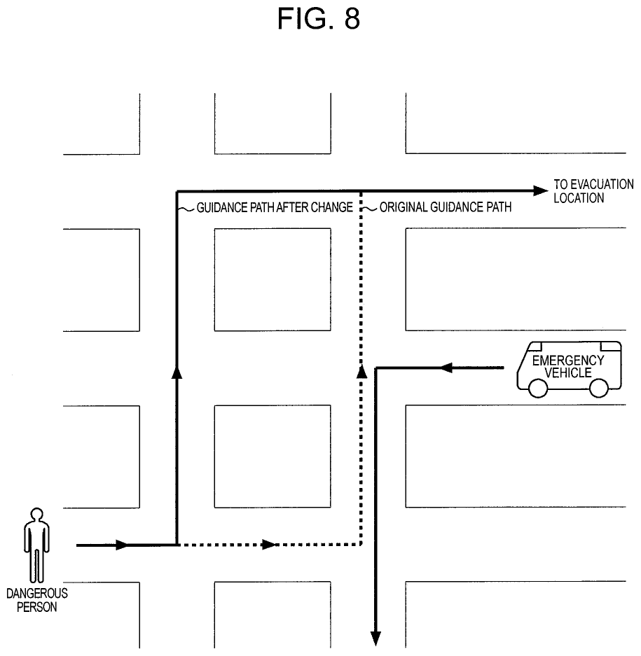

Next, a modification example of the first exemplary embodiment will be described. Points not particularly mentioned here are the same as the above exemplary embodiment. FIG. 8 is a descriptive diagram illustrating a situation of path guidance according to a modification example of the first exemplary embodiment.

In a case where the dangerous person (a person frequently performing the dangerous behavior) is present, an emergency vehicle such as an ambulance may not be able to smoothly pass due to the dangerous behavior of the person. Therefore, in the present modification example, in a case where the emergency vehicle approaches the dangerous person, the dangerous person is provided with a path along which the emergency vehicle does not pass. In the example illustrated in FIG. 8, the emergency vehicle approaches after the dangerous person starts evacuating in accordance with the path guidance of roadside machine 5. Thus, the guidance path is changed to a path along which the emergency vehicle does not pass in the middle of evacuation. Accordingly, it is possible to avoid the emergency vehicle not being able to smoothly pass due to the dangerous behavior of the dangerous person such as sudden entrance.

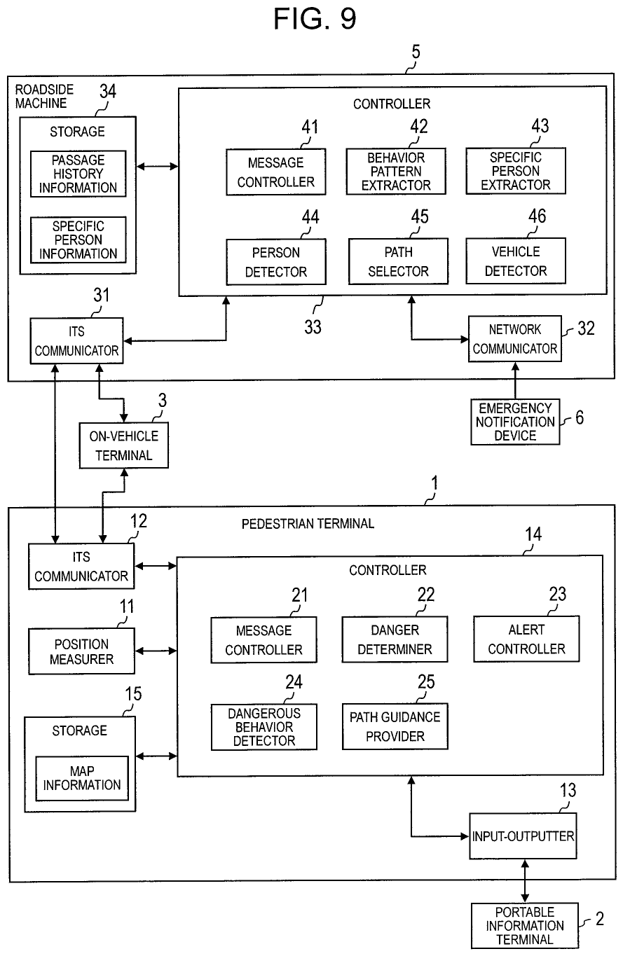

Next, schematic configurations of pedestrian terminal 1 and roadside machine 5 according to the modification example of the first exemplary embodiment will be described. FIG. 9 is a block diagram illustrating the schematic configurations of pedestrian terminal 1 and roadside machine 5.

Pedestrian terminal 1 has the same configuration as the first exemplary embodiment (refer to FIG. 4).

While roadside machine 5 also has approximately the same configuration as the first exemplary embodiment (refer to FIG. 4), controller 33 includes vehicle detector 46. Vehicle detector 46 detects the emergency vehicle present nearby the host device based on the attribute information included in the message transmitted from on-vehicle terminal 3.

In a case where on-vehicle terminal 3 of the emergency vehicle acquires movement path information from car navigation device 4 and transmit the movement path information by adding the movement path information to the message, roadside machine 5 can acquire the movement path information of the emergency vehicle. In addition, the movement path information of the emergency vehicle may be acquired from a management device that manages dispatch of the emergency vehicle. In this case, the movement path information transmitted from the management device installed at a fire station or the like may be received by network communicator 32 through a network.

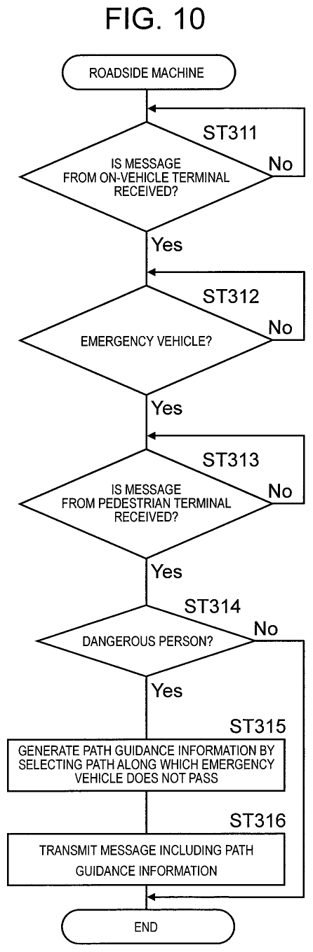

Next, an operation procedure at a time of user assistance in roadside machine 5 according to a modification example of the first exemplary embodiment will be described. FIG. 10 is a flowchart illustrating the operation procedure of roadside machine 5.

In roadside machine 5, in a case where the message transmitted from on-vehicle terminal 3 is received by ITS communicator 31 (Yes in ST311), a determination as to whether or not the emergency vehicle is present nearby the host device is performed based on the attribute information included in the message (ST312).

In a case where the emergency vehicle is present nearby the host device (Yes in ST312), and the message transmitted from pedestrian terminal 1 is received (Yes in ST313), next, person detector 44 determines whether or not the pedestrian is the dangerous person (a person frequently performing the dangerous behavior) based on the terminal ID included in the message and the specific person information of storage 34 (ST314).

In a case where the pedestrian is the dangerous person (Yes in ST314), path selector 45 generates the path guidance information by selecting a path along which the emergency vehicle does not pass (ST315).

Next, message controller 41 generates the message including the path guidance information and transmits the message to pedestrian terminal 1 of the dangerous person from ITS communicator 31 (ST316).

### Second Exemplary Embodiment

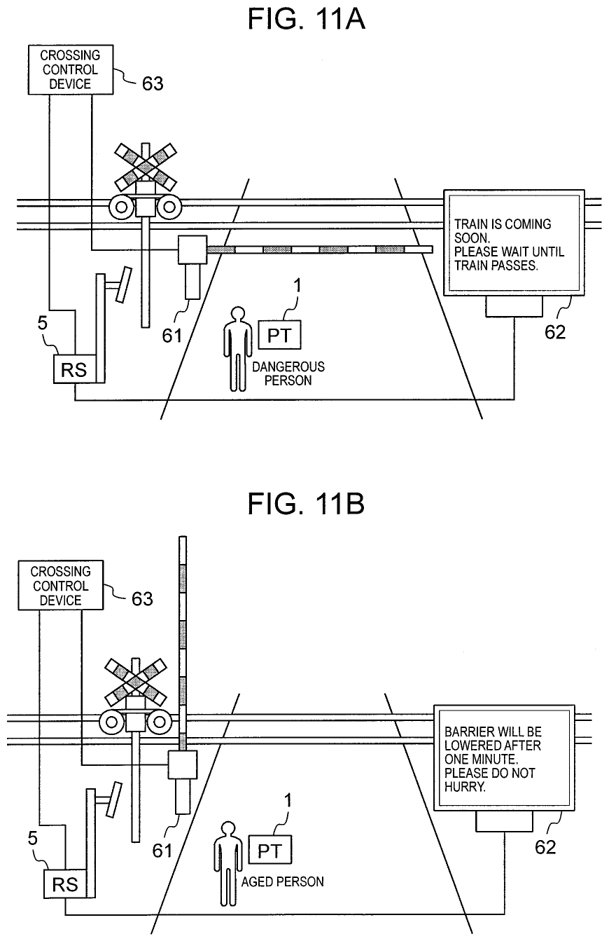

Next, a second exemplary embodiment will be described. Points not particularly mentioned here are the same as the above exemplary embodiment. FIG. 11A and FIG. 11B are descriptive diagrams illustrating a summary of a communication system according to the second exemplary embodiment.

At a crossing, even in a lowered state of barrier 61, the dangerous person (a person frequently performing the dangerous behavior) may try to pass through the crossing below barrier 61, and such a situation is significantly dangerous. Therefore, in the present exemplary embodiment, when the dangerous person approaches the crossing and barrier 61 is in the lowered state, guidance is provided for not performing a behavior of forcibly passing through the crossing. Accordingly, a crossing accident of the dangerous person can be prevented.

In addition, in a case of the aged person, the aged person may not move due to a change in body condition in the middle of passing through the crossing, or a wheel of a cart may be stuck on a rough surface of the crossing and may not move. Thus, it takes time to pass through the crossing. Accordingly, barrier 61 may be lowered while the aged person is crossing the crossing, and such a situation is significantly dangerous. Therefore, in the present exemplary embodiment, in a case where there is no sufficient time until the lowering of barrier 61 when the aged person approaches the crossing, guidance is provided for not performing a behavior of forcibly passing through the crossing. Accordingly, a crossing accident of the aged person can be prevented.

Roadside machine 5 and digital signage 62 (display device) are installed near the crossing. Digital signage 62 is controlled by roadside machine 5. Roadside machine 5 can communicate with crossing control device 63 that controls barrier 61. Roadside machine 5 acquires operation information (an operation schedule and the current operation state) of barrier 61 from crossing control device 63.

Roadside machine 5 detects the pedestrian approaching the crossing based on the message transmitted from pedestrian terminal 1. In a case where the pedestrian approaching the crossing is the dangerous person (a person frequently performing the dangerous behavior), a guidance screen for the dangerous person is displayed on digital signage 62. In addition, in a case where the pedestrian approaching the crossing is the aged person, a guidance screen for the aged person is displayed on digital signage 62.

As illustrated in FIG. 11A, in a case of the dangerous person, it is necessary to restrict the behavior of forcibly passing through barrier 61 in the lowered state of barrier 61 (a passage prohibition state). Thus, in the present exemplary embodiment, in a case where barrier 61 is in the lowered state, the guidance screen for the dangerous person is displayed on digital signage 62 based on the operation information of barrier 61 acquired from crossing control device 63. In addition, in the guidance screen for the dangerous person, for example, a text “Train is coming soon. Please wait until train passes” is displayed as a content for restricting the behavior of passing through barrier 61.

In addition, as illustrated in FIG. 11B, in the case of the aged person, it is necessary to provide guidance for not performing the behavior of passing through the crossing in a case where there is no sufficient time until the lowering of barrier 61. Thus, in the present exemplary embodiment, considering the amount of time in which the aged person can pass through the crossing, a threshold of the remaining amount of time until barrier 61 enters the lowered state is set, and the guidance screen for the aged person is displayed on digital signage 62 at a timing at which the remaining amount of time becomes less than or equal to the threshold. In addition, in the guidance screen for the aged person, for example, a text “Barrier will be lowered after one minute. Please do not hurry.” is displayed as a content for prompting the aged person not to perform the behavior of passing through the crossing.

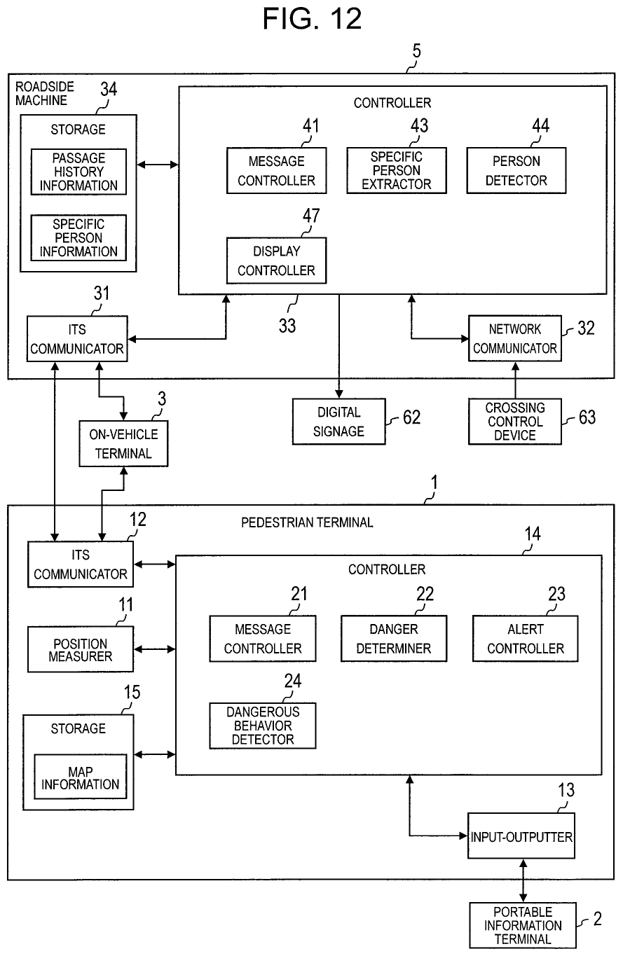

Next, schematic configurations of pedestrian terminal 1 and roadside machine 5 according to the second exemplary embodiment will be described. FIG. 12 is a block diagram illustrating the schematic configurations of pedestrian terminal 1 and roadside machine 5.

Pedestrian terminal 1 has approximately the same configuration as the first exemplary embodiment (refer to FIG. 4) and includes position measurer 11, ITS communicator 12, input-outputter 13, controller 14, and storage 15. Controller 14 includes message controller 21, danger determiner 22, alert controller 23, and dangerous behavior detector 24.

Roadside machine 5 has approximately the same configuration as the first exemplary embodiment (refer to FIG. 4) and includes ITS communicator 31, network communicator 32, controller 33, and storage 34. Network communicator 32 communicates with crossing control device 63 and receives the operation information of barrier 61 transmitted from crossing control device 63.

Controller 33 includes message controller 41, specific person extractor 43, person detector 44, and display controller 47.

Specific person extractor 43 extracts the dangerous person (a person frequently performing the dangerous behavior) based on the dangerous behavior information in the passage history information of storage 34 and stores the dangerous person in storage 34 as the specific person information in the same manner as the first exemplary embodiment.

Person detector 44 detects the pedestrian approaching a predetermined distance or shorter from the crossing based on the positional information included in the message received from pedestrian terminal 1 by ITS communicator 31. A determination as to whether or not the aged person approaches the crossing is performed based on the attribute information included in the message. In addition, a determination as to whether or not the dangerous person (a person frequently performing the dangerous behavior) approaches the crossing is performed based on the terminal ID included in the message and the specific person information of storage 34.

Display controller 47 controls digital signage 62 and displays the guidance screen on digital signage 62. In the present exemplary embodiment, in a case where barrier 61 is in the lowered state (the passage prohibition state) and person detector 44 detects the dangerous person (a person frequently performing the dangerous behavior) approaching the crossing, the guidance screen for the dangerous person is displayed (refer to FIG. 11A). In addition, in a case where the remaining amount of time until the barrier enters the lowered state is less than or equal to a predetermined value (for example, one minute) and person detector 44 detects the aged person approaching the crossing, the guidance screen (refer to FIG. 11B) for the aged person is displayed.

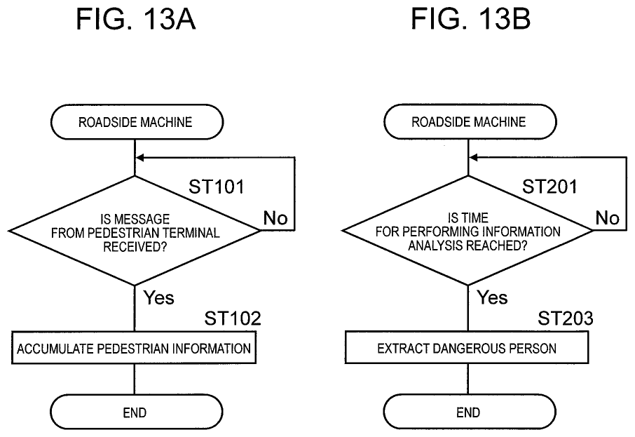

Next, an operation procedure at a time of information reception and a time of information analysis in roadside machine 5 according to the second exemplary embodiment will be described. FIG. 13A and FIG. 13B are flowcharts illustrating the operation procedure of roadside machine 5.

As illustrated in FIG. 13A, roadside machine 5 has the same operation procedure as the first exemplary embodiment (refer to FIG. 6A) at the time of information reception.

As illustrated in FIG. 13B, in roadside machine 5, in a case where a time (timing) for performing the information analysis is reached (Yes in ST201), specific person extractor 43 extracts the dangerous person (a person frequently performing the dangerous behavior) based on the dangerous behavior information in the passage history information of storage 34 and stores the dangerous person in storage 34 as the specific person information as the information analysis (ST203).

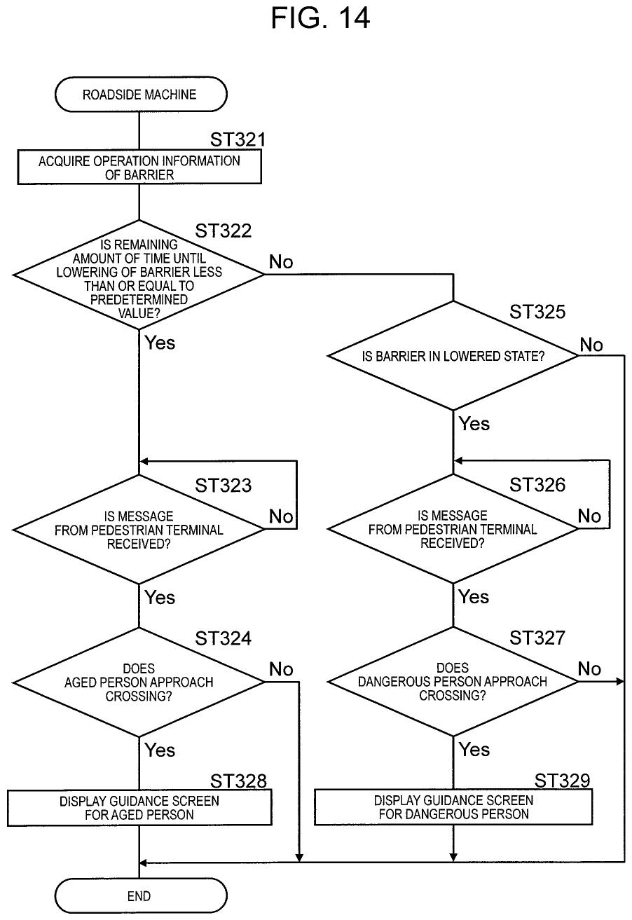

Next, an operation procedure at a time of user assistance in roadside machine 5 according to the second exemplary embodiment will be described. FIG. 14 is a flowchart illustrating the operation procedure of roadside machine 5.

In roadside machine 5, the operation information of barrier 61 is acquired from crossing control device 63 (ST321). A determination as to whether or not the remaining amount of time until barrier 61 enters the lowered state (the passage prohibition state) is less than or equal to the predetermined value is performed based on the operation information of barrier 61 (ST322).

In a case where the remaining amount of time until barrier 61 enters the lowered state is less than or equal to the predetermined value (Yes in ST322), and the message transmitted from pedestrian terminal 1 is received (Yes in ST323), next, person detector 44 determines whether or not the aged person approaches the crossing based on the positional information and the attribute information included in the message (ST324).

In a case where the aged person approaches the crossing (Yes in ST324), display controller 47 displays the guidance screen (refer to FIG. 11B) for the aged person on digital signage 62 (ST328).

Meanwhile, in a case where the remaining amount of time until barrier 61 enters the lowered state is not less than or equal to the predetermined value (No in ST322), next, a determination as to whether or not barrier 61 is in the lowered state is performed (ST325). In a case where barrier 61 is in the lowered state (Yes in ST325), and the message transmitted from pedestrian terminal 1 is received (Yes in ST326), next, person detector 44 determines whether or not the dangerous person (a person frequently performing the dangerous behavior) approaches the crossing based on the terminal ID included in the message and the specific person information of storage 34 (ST327).

In a case where the dangerous person approaches the crossing (Yes in ST327), display controller 47 displays the guidance screen (refer to FIG. 11A) for the dangerous person on digital signage 62 (ST329).

Meanwhile, in a case where the barrier is not in the lowered state (No in ST325), there is a predetermined amount of time until the barrier is lowered. Thus, no particular process is performed. However, at this point, for example, the remaining amount of time until the barrier is lowered may be displayed on digital signage 62.

In the present exemplary embodiment, the guidance screen is displayed on digital signage 62. Alternatively, audio guidance may be provided. In addition, the guidance screen may be displayed on the display device of the vending machine, the power pole, or the like installed near the crossing instead of digital signage 62, or the audio guidance may be provided from a speaker of the vending machine, the power pole, or the like.

In addition, roadside machine 5 may include behavior pattern extractor 42 in the same manner as the first exemplary embodiment. Behavior pattern extractor 42 may extract the passage history information of the care-needed person such as the aged person based on the attribute information of each pedestrian in the passage history information of storage 34, acquire a necessary amount of time for the care-needed person to pass through the crossing as the behavior pattern information based on the positional information (an entrance and an exit of the crossing) in the passage history information of the care-needed person, and set the necessary amount of time as the predetermined value to be compared with the remaining amount of time until barrier 61 enters the lowered state.

In addition, a day of the week and a time range in which the dangerous person passes through the crossing may be acquired as the behavior pattern information based on the passage history information. In a case where the day of the week and the time range in which the dangerous person passes through the crossing are reached, the guidance screen for the dangerous person may be displayed on digital signage 62 based on the behavior pattern information. In addition, a day of the week and a time range in which the care-needed person such as the aged person passes through the crossing may be acquired as the behavior pattern information. In a case where the day of the week and the time range in which the care-needed person passes through the crossing are reached, the guidance screen for the care-needed person may be displayed on digital signage 62 based on the behavior pattern information.

In addition, in the present exemplary embodiment, a case where the aged person passes through the crossing is described. However, besides the aged person, the same can be applied to a case where the care-needed person such as the physically disabled person or the pregnant woman passes through the crossing. In that case, a necessary amount of time for passing through the crossing may be extracted for each attribute information of the physically disabled person, the pregnant woman, or the like based on the positional information (the entrance and the exit of the crossing) and the attribute information in the passage history information. The predetermined value to be compared with the remaining amount of time until barrier 61 enters the lowered state, the attribute information of the person approaching the crossing, and the display content of the guidance screen may be appropriately changed.

### Third Exemplary Embodiment

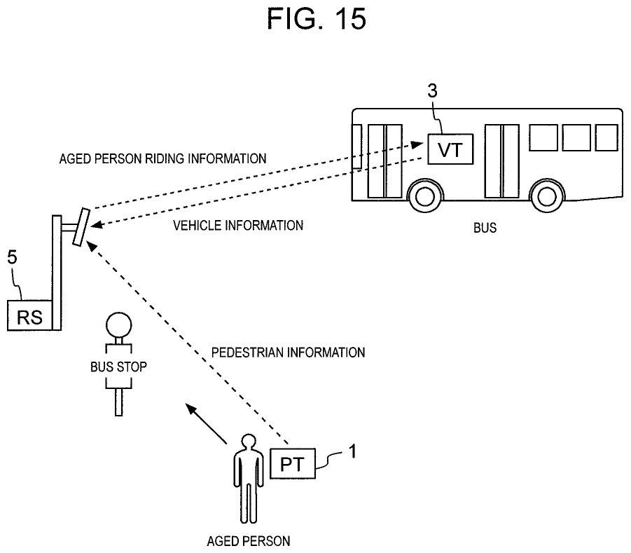

Next, a third exemplary embodiment will be described. Points not particularly mentioned here are the same as the above exemplary embodiment. FIG. 15 is a descriptive diagram illustrating a summary of a communication system according to the third exemplary embodiment.

The aged person mostly uses a bus for going to a fixed facility such as a hospital, a welfare facility, or a shopping center. Particularly, the aged person mostly uses the bus at a fixed time (destination) on a fixed day of the week. Therefore, in the present exemplary embodiment, in roadside machine 5 installed at a bus stop, a day of the week and a time range in which the aged person rides on the bus are acquired in advance based on the passage history information. In a case where the aged person moving toward the bus stop is detected, a notification of riding of the aged person at the bus stop is given to an operator of the bus in a case where the day of the week and the time range in which the aged person rides on the bus are reached. Accordingly, it is possible to avoid the aged person missing the bus. In addition, a seat for the aged person can be secured by in-vehicle announcement.

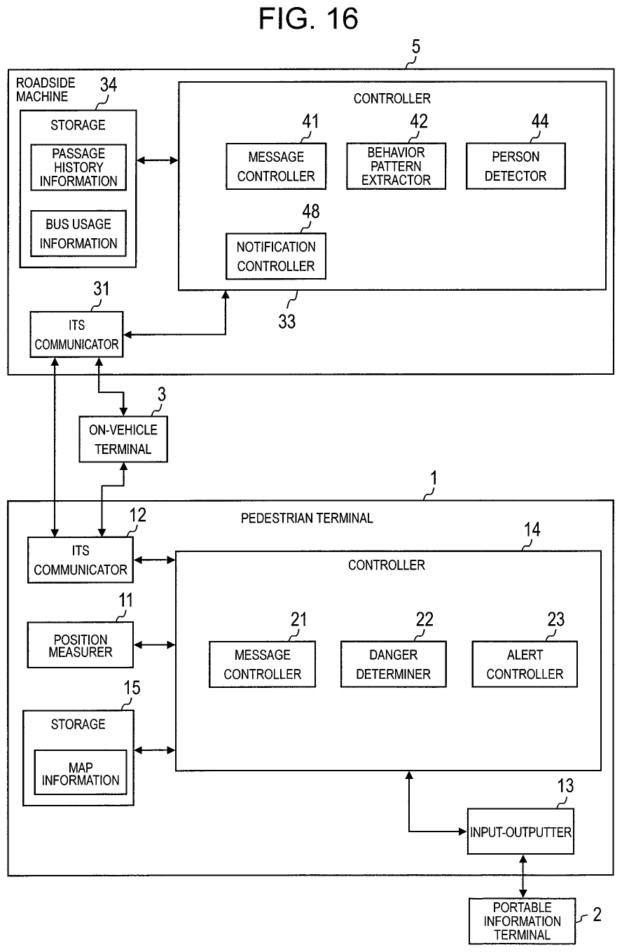

Next, schematic configurations of pedestrian terminal 1 and roadside machine 5 according to the third exemplary embodiment will be described. FIG. 16 is a block diagram illustrating the schematic configurations of pedestrian terminal 1 and roadside machine 5.

Pedestrian terminal 1 is approximately the same as pedestrian terminal 1 of the first exemplary embodiment (refer to FIG. 4) and includes position measurer 11, ITS communicator 12, input-outputter 13, controller 14, and storage 15. Controller 14 includes message controller 21, danger determiner 22, and alert controller 23.

Roadside machine 5 is approximately the same as roadside machine 5 of the first exemplary embodiment (refer to FIG. 4) and includes ITS communicator 31, controller 33, and storage 34. Controller 33 includes message controller 41, behavior pattern extractor 42, person detector 44, and notification controller 48.

Behavior pattern extractor 42 acquires bus usage information (behavior pattern information) related to the day of the week and the time range in which the aged person rides on the bus for each aged person based on the passage history information of storage 34. In this process, the passage history information of the aged person of the terminal ID is extracted based on the attribute information and the terminal ID in the passage history information, and the aged person riding on the bus is detected based on the positional information in the passage history information of the aged person. At this point, in a case where the aged person moves in a direction of the bus stop and stays for a predetermined amount of time or longer near the bus stop, it is determined that the aged person rides on the bus.

Person detector 44 detects the aged person moving toward the bus stop based on the positional information and the attribute information included in the message received from pedestrian terminal 1 by ITS communicator 31.

In a case where person detector 44 detects the aged person approaching the bus stop, notification controller 48 determines whether or not to perform communication that the aged person rides on the bus depending on whether or not the day of the week and the time range in which the aged person rides on the bus are reached, based on the bus usage information (behavior pattern information) corresponding to the terminal ID of the aged person stored in storage 34.

In a case where notification controller 48 determines to give the notification, message controller 41 transmits the message including riding notification information to on-vehicle terminal 3 of the bus from ITS communicator 31. The riding notification information indicates that the aged person rides on the bus.

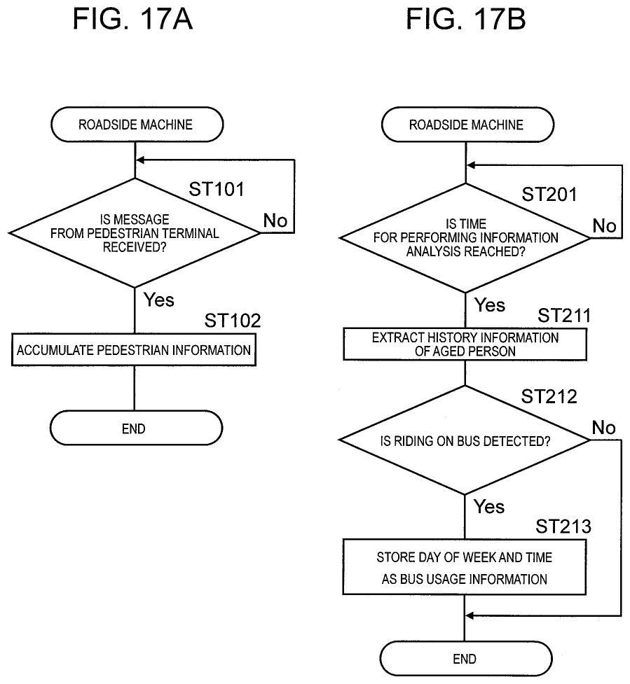

Next, an operation procedure at a time of information reception and a time of information analysis in roadside machine 5 according to the third exemplary embodiment will be described. FIG. 17A and FIG. 17B are flowcharts illustrating the operation procedure of roadside machine 5.

As illustrated in FIG. 17A, roadside machine 5 has the same operation procedure as the first exemplary embodiment (refer to FIG. 6A) at the time of information reception.

As illustrated in FIG. 17B, in roadside machine 5, in a case where a time (timing) for performing the information analysis is reached (Yes in ST201), behavior pattern extractor 42 performs a process of acquiring the bus usage information related to the day of the week and the time range in which the aged person rides on the bus based on the passage history information of storage 34 as the information analysis (ST211 to ST213).

Specifically, first, the passage history information of the aged person is extracted based on the attribute information in the passage history information (ST211). A determination as to whether or not the aged person rides on the bus is performed based on the positional information in the passage history information of the aged person (ST212).

In a case where the aged person riding on the bus is detected (Yes in ST212), the day of the week and the time at the time of detection are acquired, and the day of the week and the time are stored in storage 34 as the bus usage information corresponding to the terminal ID of the aged person (ST213).

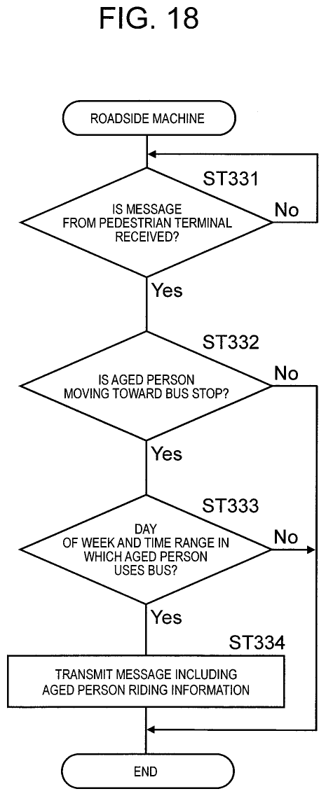

Next, an operation procedure at a time of user assistance in roadside machine 5 according to the third exemplary embodiment will be described. FIG. 18 is a flowchart illustrating the operation procedure of roadside machine 5.

In roadside machine 5, in a case where the message transmitted from pedestrian terminal 1 is received by ITS communicator 31 (Yes in ST331), person detector 44 determines whether or not the aged person is moving toward the bus stop based on the pedestrian information included in the received message (ST332). At this point, a determination as to whether or not the pedestrian is the aged person is performed based on the attribute information in the pedestrian information. In addition, a determination as to whether or not the pedestrian is moving toward the bus stop is performed based on the positional information in the pedestrian information.

In a case where the aged person is moving toward the bus stop (Yes in ST332), next, notification controller 48 determines whether or not the day of the week and the time range in which the aged person uses the bus are reached based on the bus usage information of storage 34 corresponding to the terminal ID of the aged person (ST333).

In a case where the day of the week and the time range in which the aged person uses the bus are reached (Yes in ST333), message controller 41 generates the message including aged person riding information that indicates that the aged person rides on the bus, and transmits the message to on-vehicle terminal 3 of the bus from ITS communicator 31 (ST334). At this point, in a case where the terminal ID of the riding aged person is added to the transmitted message, on-vehicle terminal 3 can recognize the terminal ID of the riding aged person.

In on-vehicle terminal 3, in a case where the message transmitted from roadside machine 5 is received, the notification of the riding of the aged person at the bus stop is given to the operator of the bus using car navigation device 4 mounted in the vehicle. On-vehicle terminal 3 may give a notification of the actual riding of the notified aged person to the operator of the bus using car navigation device 4 by comparing the terminal ID in the message of the aged person riding information with the terminal ID of pedestrian terminal 1 possessed by the riding person. Furthermore, as car navigation device 4 gives the notification of the riding to the operator of the bus, car navigation device 4 may calculate a charge between bus stops from a section in which the positional information from on-vehicle terminal 3 matches the positional information of pedestrian terminal 1 of the actually riding pedestrian, and may collect a bus fare from a user of the terminal ID later.

In the present exemplary embodiment, a case where the aged person uses the bus is described. However, besides the aged person, the same can be applied to a case where the care-needed person such as the physically disabled person or the pregnant woman uses the bus.

In addition, besides the bus, for example, the present invention can be applied to a case where the aged person uses a taxi. In this case, a determination as to whether or not the pedestrian is moving in a direction of a taxi stand or the like is performed based on the positional information in the pedestrian information.

### Fourth Exemplary Embodiment

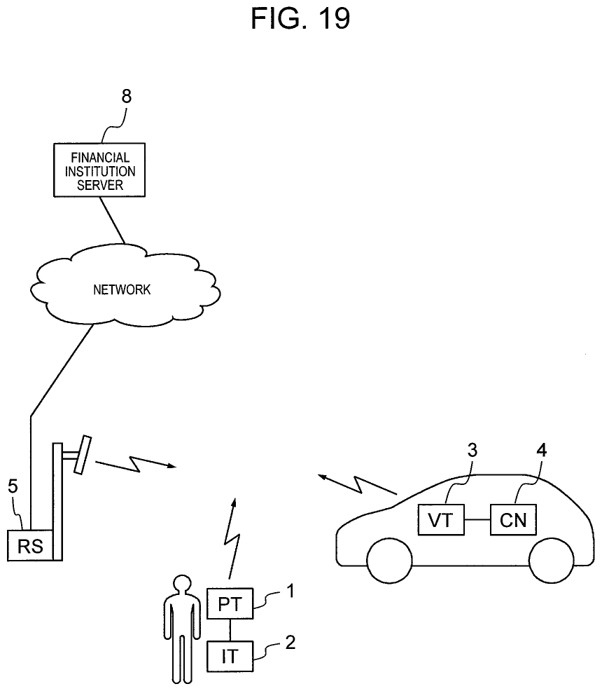

Next, a fourth exemplary embodiment will be described. Points not particularly mentioned here are the same as the above exemplary embodiment. FIG. 19 is an overall configuration diagram of a communication system according to the fourth exemplary embodiment. In the present exemplary embodiment, the path guidance illustrated in the first exemplary embodiment will be performed as a pedestrian assistance service. However, pedestrian assistance services illustrated in other exemplary embodiments may also be performed.

In the present exemplary embodiment, a user of pedestrian terminal 1 performs a registration operation with respect to use of the pedestrian assistance service, and a service usage fee (for example, 100 yen per month) is collected from the user who receives the pedestrian assistance service.

Roadside machine 5 can communicate with financial institution server 8 that is installed at a financial institution such as a credit company or a bank through a network of the Internet or the like. Financial institution server 8 performs money transfer (withdrawal) for collection depending on information from roadside machine 5.

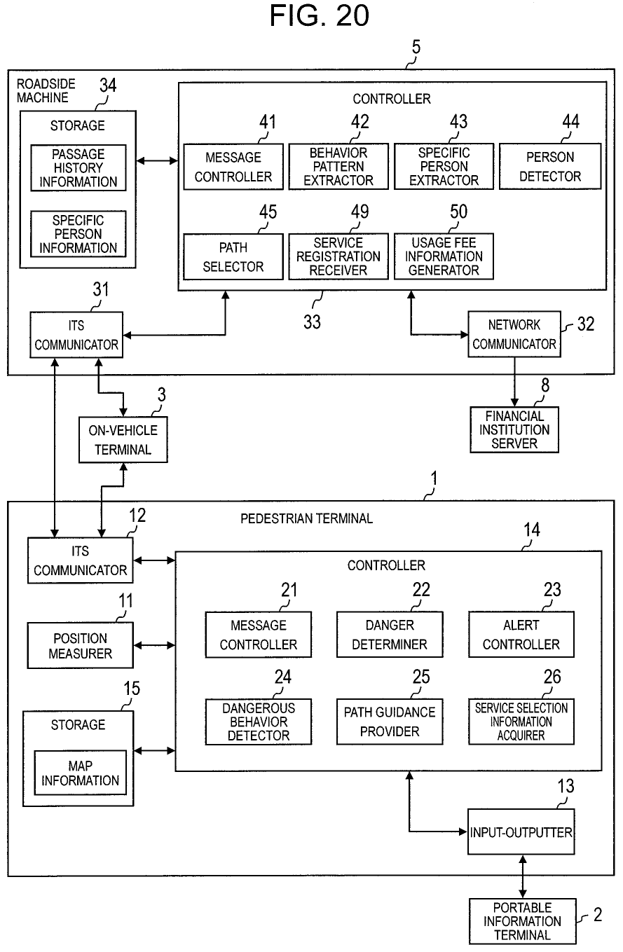

Next, schematic configurations of pedestrian terminal 1 and roadside machine 5 according to the fourth exemplary embodiment will be described. FIG. 20 is a block diagram illustrating the schematic configurations of pedestrian terminal 1 and roadside machine 5.

While pedestrian terminal 1 has approximately the same configuration as the first exemplary embodiment (refer to FIG. 4), controller 14 includes service selection information acquirer 26. Service selection information acquirer 26 acquires service selection information related to the use of the pedestrian assistance service by causing the user to perform the registration operation with respect to the use of the pedestrian assistance service. The service selection information is transmitted to roadside machine 5 from ITS communicator 12 by adding the service selection information to the message. A selection operation of the user may be performed in portable information terminal 2.

While roadside machine 5 has approximately the same configuration as the first exemplary embodiment (refer to FIG. 4), network communicator 32 communicates with financial institution server 8.

Controller 33 includes service registration receiver 49 and usage fee information generator 50.

Service registration receiver 49 receives registration of each user related to the use of the pedestrian assistance service based on the service selection information included in the message received from pedestrian terminal 1.

Usage fee information generator 50 generates usage fee information related to the collection of the usage fee for the use of the pedestrian assistance service. The usage fee information is transmitted to financial institution server 8, and financial institution server 8 is requested to perform the money transfer (withdrawal) for the collection.

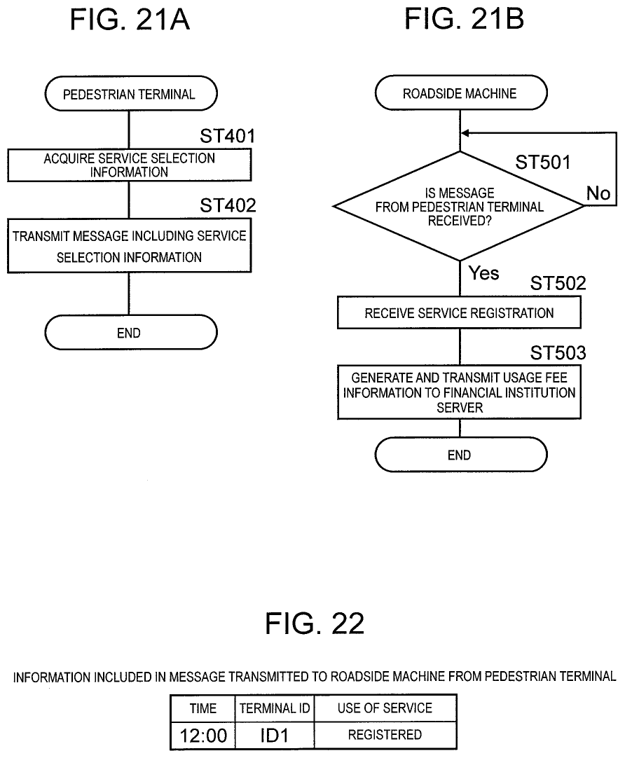

Next, operation procedures of pedestrian terminal 1 and roadside machine 5 according to the fourth exemplary embodiment will be described. FIG. 21A and FIG. 21B are flowcharts illustrating the operation procedures of pedestrian terminal 1 and roadside machine 5. FIG. 22 is a descriptive diagram illustrating one example of information included in the message.

As illustrated in FIG. 21A, in pedestrian terminal 1, service selection information acquirer 26 acquires the service selection information related to the use of the pedestrian assistance service by causing the user to perform the registration operation with respect to the use of the pedestrian assistance service (ST401). Message controller 21 transmits the message including the service selection information to roadside machine 5 from ITS communicator 12 (ST402).

At this point, as illustrated in FIG. 22, the message transmitted to roadside machine 5 from pedestrian terminal 1 includes the time, the terminal ID, and the service selection information related to registration for the pedestrian assistance service.

As illustrated in FIG. 21B, in roadside machine 5, in a case where the message transmitted from pedestrian terminal 1 is received by ITS communicator 31 (Yes in ST501), service registration receiver 49 receives registration of each user related to the use of the pedestrian assistance service based on the service selection information included in the message (ST502). By this registration, the terminal ID of pedestrian terminal 1 included in the message is stored in roadside machine 5 as a service user and can receive the pedestrian assistance service such as the path guidance afterward.

Next, usage fee information generator 50 generates the usage fee information related to the collection of the usage fee for the use of the pedestrian assistance service and transmits the usage fee information to financial institution server 8 (ST503).

### Fifth Exemplary Embodiment

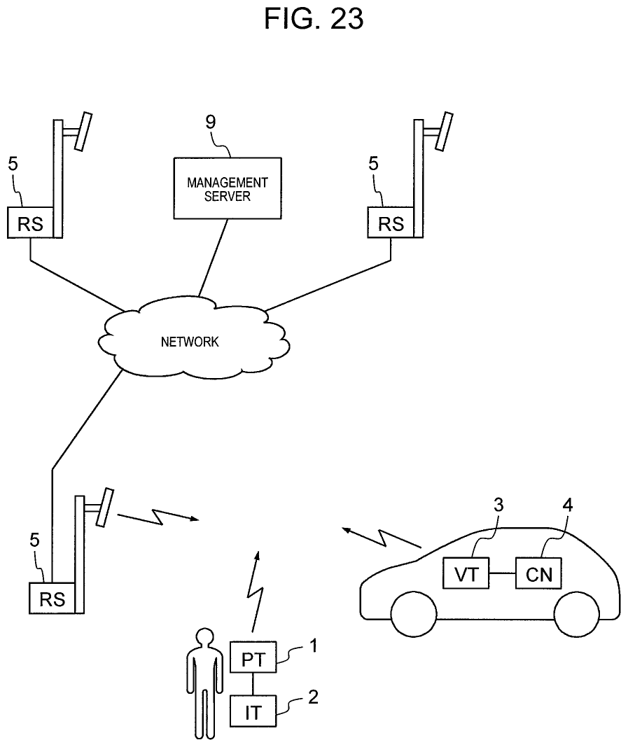

Next, a fifth exemplary embodiment will be described. Points not particularly mentioned here are the same as the above exemplary embodiment. FIG. 23 is an overall configuration diagram of a communication system according to the fifth exemplary embodiment.

In the above exemplary embodiments, roadside machine 5 performs a process related to the pedestrian assistance service. Alternatively, management server 9 connected to roadside machine 5 through a network of the Internet or the like may be disposed. Management server 9 may perform the process related to the pedestrian assistance service by collecting information from a plurality of roadside machines 5. Accordingly, the pedestrian assistance service can be performed in a wide area as a target.

As the process related to the pedestrian assistance service, management server 9 performs the process performed by roadside machine 5 in each of the above exemplary embodiments. That is, management server 9 performs various processes for the path guidance as in the first exemplary embodiment. In addition, management server 9 performs various processes for the guidance at the crossing as in the second exemplary embodiment. In addition, management server 9 performs various processes for the notification of the riding on the bus as in the third exemplary embodiment. In addition, management server 9 performs various processes for the collection of the usage fee of the pedestrian assistance service as in the fourth exemplary embodiment.

At this point, management server 9 performs the process related to the pedestrian assistance service by acquiring the passage history information accumulated in roadside machine 5 from each roadside machine 5 at an appropriate timing and acquiring the pedestrian information included in the message received from pedestrian terminal 1 from each roadside machine 5 at all times. In addition, as in the first exemplary embodiment, the path guidance information notified to the pedestrian by pedestrian terminal 1 may be transmitted to roadside machine 5 and then, be transmitted to pedestrian terminal 1 from roadside machine 5 by adding the path guidance information to the message. Crossing guidance information displayed on digital signage 62 may be transmitted to roadside machine 5. The aged person riding information notified to the operator of the bus by on-vehicle terminal 3 may be transmitted to roadside machine 5 and then, be transmitted to on-vehicle terminal 3 of the bus from roadside machine 5 by adding the aged person riding information to the message.

The exemplary embodiments have been described thus far as illustrations of the technology disclosed in the present application. However, the technology in the present disclosure is not limited to the exemplary embodiments and can also be applied to exemplary embodiments to which changes, replacement, addition, omission, and the like are made. In addition, new exemplary embodiments can be made by combining each of the constituents described in the exemplary embodiments.

### INDUSTRIAL APPLICABILITY

The roadside device, the communication system, and the pedestrian assistance method according to the present invention have an effect of enabling generation of information for assisting the pedestrian based on information collected from the pedestrian terminal, and are useful as a roadside device that is installed on a road and performs road-pedestrian communication with a pedestrian device which performs a danger determination by exchanging a message including positional information with an on-vehicle device, a communication system in which the pedestrian device and the roadside device perform the road-pedestrian communication, and a pedestrian assistance method of generating information for assisting a pedestrian by collecting information from a nearby pedestrian device in the roadside device.

### REFERENCE MARKS IN THE DRAWINGS

1 PEDESTRIAN TERMINAL (PEDESTRIAN DEVICE)
3 ON-VEHICLE TERMINAL (ON-VEHICLE DEVICE)
5 ROADSIDE MACHINE (ROADSIDE DEVICE)
6 EMERGENCY NOTIFICATION DEVICE
8 FINANCIAL INSTITUTION SERVER
9 MANAGEMENT SERVER
11 POSITION MEASURER
12 ITS COMMUNICATOR
13 INPUT-OUTPUTTER
14 CONTROLLER
15 STORAGE
31 ITS COMMUNICATOR
32 NETWORK COMMUNICATOR
33 CONTROLLER
34 STORAGE
61 BARRIER
62 DIGITAL SIGNAGE (DISPLAY DEVICE)
63 CROSSING CONTROL DEVICE

1. A roadside device that is installed on a road and performs road-pedestrian communication with a pedestrian device which performs a danger determination by exchanging a message including positional information with an on-vehicle device, the roadside device comprising:
a communicator that performs the road-pedestrian communication with the pedestrian device;
a storage in which in a case where the message transmitted from the pedestrian device is received by the communicator, pedestrian information included in the received message is accumulated as passage history information; and
a controller that generates pedestrian assistance information for assisting a pedestrian based on the passage history information.

2. The roadside device of claim 1,
wherein the controller transmits the message including the pedestrian assistance information to the pedestrian device present nearby from the communicator.

3. The roadside device of claim 1,
wherein the controller displays the pedestrian assistance information on a display device.

4. The roadside device of claim 1,
wherein the controller transmits the message including the pedestrian assistance information to the on-vehicle device present nearby from the communicator.

5. The roadside device of claim 1,
wherein the communicator receives the message including attribute information of the pedestrian from the pedestrian device, and
the controller acquires behavior pattern information of the pedestrian having a specific attribute based on the passage history information and generates the pedestrian assistance information for the pedestrian having the specific attribute as a target based on the behavior pattern information.

6. The roadside device of claim 5,
wherein the controller acquires the behavior pattern information related to a regular path of a care-needed person based on the passage history information, selects the regular path based on the behavior pattern information in a case where the care-needed person is detected based on the attribute information included in the message transmitted from the pedestrian device, and generates path guidance information as the pedestrian assistance information for the care-needed person as a target.

7. The roadside device of claim 5,
wherein the controller acquires the behavior pattern information related to a time range in which a care-needed person rides on a bus based on the passage history information, generates riding information indicating that the care-needed person rides on the bus as the pedestrian assistance information in a case where the care-needed person approaching a bus stop is detected based on the positional information and the attribute information included in the message transmitted from the pedestrian device and the time range in which the care-needed person rides on the bus is reached based on the behavior pattern information, and transmits the message including the riding information to the on-vehicle device of the bus from the communicator.

8. The roadside device of claim 5,
wherein the controller acquires the behavior pattern information related to a crossing of a care-needed person based on the passage history information, and generates crossing guidance information as the pedestrian assistance information for the care-needed person as a target based on the behavior pattern information in a case where the care-needed person approaching the crossing is detected based on the attribute information and the positional information included in the message transmitted from the pedestrian device.

9. The roadside device of claim 1,
wherein the controller extracts the pedestrian having a specific characteristic based on the passage history information and generates the pedestrian assistance information for the pedestrian having the specific characteristic as a target.

10. The roadside device of claim 9,
wherein the controller extracts the pedestrian who performs a dangerous behavior a predetermined number of times or more during a predetermined period as a dangerous person based on the passage history information, selects a path on which a vehicle traffic amount per unit time is less than or equal to a predetermined number in a case where the dangerous person is detected based on identification information included in the message transmitted from the pedestrian device, and generates path guidance information as the pedestrian assistance information for the dangerous person as a target.

11. The roadside device of claim 9,
wherein the controller extracts the pedestrian who performs a dangerous behavior a predetermined number of times or more during a predetermined period as a dangerous person based on the passage history information, selects a path along which an emergency vehicle does not pass in a case where the emergency vehicle is detected based on the attribute information included in the message transmitted from the on-vehicle device and the dangerous person is detected based on the attribute information included in the message transmitted from the pedestrian device, and generates path guidance information as the pedestrian assistance information for the dangerous person as a target.

12. The roadside device of claim 9,
wherein the controller extracts the pedestrian who performs a dangerous behavior a predetermined number of times or more during a predetermined period as a dangerous person based on the passage history information, and generates crossing guidance information as the pedestrian assistance information for the dangerous person as a target in a case where the dangerous person approaching a crossing is detected based on identification information and the positional information included in the message transmitted from the pedestrian device.

13. A communication system comprising:
a pedestrian device that performs a danger determination by exchanging a message including positional information with an on-vehicle device; and
a roadside device installed on a road,
wherein the pedestrian device and the roadside device perform road-pedestrian communication, and
the roadside device includes
a communicator that performs the road-pedestrian communication with the pedestrian device,
a storage in which in a case where the message transmitted from the pedestrian device is received by the communicator, pedestrian information included in the received message is accumulated as passage history information, and
a controller that generates pedestrian assistance information for assisting a pedestrian based on the passage history information.

14. The communication system of claim 13,
wherein a controller of the pedestrian device transmits service selection information related to use of a pedestrian assistance service from the communicator of the pedestrian device, and
the controller of the roadside device generates information related to collection of a service usage fee from a user of the pedestrian assistance service based on the service selection information received by the communicator of the roadside device.

15. A pedestrian assistance method of generating information for assisting a pedestrian by collecting information from a nearby pedestrian device in a roadside device installed on a road, the pedestrian assistance method comprising:
by the pedestrian device,
transmitting a message including pedestrian information to the roadside device; and
by the roadside device,
in a case where the message transmitted from the pedestrian device is received,
accumulating the pedestrian information included in the message as passage history information; and
generating pedestrian assistance information for assisting the pedestrian based on the passage history information.

16. A pedestrian assistance method of generating information for assisting a pedestrian by collecting information from a nearby pedestrian device in a roadside device installed on a road, the pedestrian assistance method comprising:
by the pedestrian device,
transmitting a message including pedestrian information to the roadside device; and
by the roadside device,
in a case where the message including attribute information of the pedestrian is received from the pedestrian device,
accumulating the pedestrian information included in the message as passage history information; and
acquiring behavior pattern information of the pedestrian having a specific attribute based on the passage history information and generating pedestrian assistance information for the pedestrian having the specific attribute as a target based on the behavior pattern information.
